(19) United States
(12) Patent Application Publication
(10) Pub. No.: US 2007/0299950 A1
(43) Pub. Date: Dec. 27, 2007

(54) System for creating optimally-sized clusters

(75) Inventor: Amit Bhavanishankar Kulkarni, Clifton Park, NY (US)

Correspondence Address: TAROLLI, SUNDHEIM, COVELL & TUMMINO LLP, Suite 1700, 1300 East Ninth Street, Cleveland, OH, 44114, US

(73) Assignees: General Electric Company; Lockheed Martin Corporation

(21) Appl. No.: 11/471,901

(22) Filed: Jun. 21, 2006

(51) Int. Cl. G06F 15/173; G06F 15/16

(52) U.S. Cl. 709/223; 709/249

(57) ABSTRACT

A system clusters nodes of a network of a plurality of nodes. The system includes: a receiver for obtaining information about a local neighborhood around a first node of the plurality of nodes, the first node having a first clusterhead node; a compiler for generating a list of clusterhead nodes; a recorder for recording weights of the clusterhead nodes of the list; a processor for computing a differential weight for the clusterhead nodes of the list; a comparator for comparing each of the differential weights with a predetermined affinity threshold; and a determinator for determining whether the first node replaces the first clusterhead node with a new clusterhead node or the first node becomes a clusterhead node.

### FIELD OF INVENTION

The present invention relates to a system for creating clusters, and more particularly, to a system for creating optimally-sized cluster groups.

### BACKGROUND OF THE INVENTION

Conventionally, ad hoc formation of groups of nodes is necessary for military battlefield networks, sensors, and fleets of vehicles. These groups of nodes ideally are formed and scaled rapidly to minimize network diameter so that information may be passed between nodes most efficiently and non-mission critical messaging overhead may be minimized.

A scalable configuration consists of groups of co-located nodes aggregated into clusters and a node in each cluster acting as a clusterhead. The clusterhead node is responsible for communication between nodes in its cluster and nodes that are in other clusters. The clusterhead nodes of each cluster may discover each other and establish routing between them. The clusterhead nodes thus form an ad-hoc infrastructure, or backbone, that is used by the non-clusterhead nodes for communication. The distribution of clusterheads and the size of the clusters is important. If there are too many clusterheads, then it can cause a lot of inter-cluster communication. If the number of clusterheads is reduced, then it will lead to larger cluster sizes. Large clusters incur high management overhead because the clusterhead obtains information about nodes that are many hops away. In a shared wireless medium, it has been shown that network capacity decreases with the increase in size of network clusters.

A configuration of nodes should be stable under small and/or transient changes in topology, yet rapidly reconfigurable when topology changes significantly (i.e., when groups of nodes join or leave, the network is partitioned, etc.). One conventional approach is a graph-theory class of algorithms including a minimum dominating set and partitioning set. However, these classes require global information and are mainly applicable to static topologies since these classes require high overhead for dynamic topologies.

Another conventional approach is voting, or election, algorithms that use extra messages for forming clusters and elect clusterheads thereby increasing overhead. A cluster size may not necessarily be optimal to reduce network diameter. Additional steps or messages may be required to identify gateways between clusters.

Still another conventional approach is evolutionary algorithms that attempt to create optimal solutions by defining a fitness function and attempt to group/regroup the node population in successive iterations to find the “optimal fit”. This approach may slowly converge and create high overhead for calculating the fitness function at every iteration.

### SUMMARY OF THE INVENTION

A system in accordance with the present invention clusters nodes of a network of a plurality of nodes. The system includes: a receiver for obtaining information about a local neighborhood around a first node of the plurality of nodes, the first node having a first clusterhead node; a compiler for generating a list of clusterhead nodes; a recorder for recording weights of the clusterhead nodes of the list; a processor for computing a differential weight for the clusterhead nodes of the list; a comparator for comparing each of the differential weights with a predetermined affinity threshold; and a determinator for determining whether the first node replaces the first clusterhead node with a new clusterhead node or the first node becomes a clusterhead node.

A computer program product in accordance with the present invention clusters nodes of a network of a plurality of nodes. The computer program product includes: a first instruction for obtaining information about a local neighborhood around a first node of the plurality of nodes, the first node having a first clusterhead node; a second instruction for generating a list of clusterhead nodes; a third instruction for recording weights of the clusterhead nodes of the list; a fourth instruction for computing a differential weight for the clusterhead nodes of the list; a fifth instruction for comparing each of the differential weights with a predetermined affinity threshold; and a sixth instruction for determining whether the first node replaces the first clusterhead node with a new clusterhead node or the first node becomes a clusterhead node.

Another system in accordance with the present invention clusters nodes of a network of a plurality of nodes. The system includes: a determinator for determining whether a node has received a hello message or a link-state message; a node list updated with a neighbor node name if a hello message from the neighbor node was determined by the determinator, the node list being updated with a node list from a neighbor node if a link-state message was determined by said determinator; a comparator for comparing a differential weight of a node from the node list with a predetermined affinity threshold; a selector for selecting a node as a clusterhead node if the node has a differential weight greater than the predetermined affinity threshold; and a calculator for calculating an increase in size of the node list.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is a schematic representation of a system for clustering nodes;

FIG. 2 is a schematic representation of factors that may affect cluster formation;

FIG. 3 is a schematic representation of a system in accordance with the present invention; and

FIG. 4 is a schematic representation of a computer program product in accordance with the present invention.

### Description of an Example Embodiment

A system in accordance with the present invention may create optimally sized clusters from a network of wireless mobile nodes using only local information available at the nodes. The system may identify gateways for the clusters and establish routing within the clusters as well as between the clusters. The system may enable the clusters to dynamically reconfigure themselves when the topology of the network changes significantly, with minimum overhead. Otherwise, the system may remain stable.

A system in accordance with the present invention may allow all nodes in a network to compute a numerical value called a “weight” based on neighborhood topology, importance, configuration, and other characteristics. The node with the highest weight in a neighborhood may become a clusterhead. Nodes having lower weights, in proximity to a clusterhead, then defer to the clusterhead node and thus join a cluster. A cluster may be a virtual grouping of nodes that have the same clusterhead node.

The clusterhead node may broadcast its weight periodically. Nodes in the cluster may rebroadcast the clusterhead address and its weight periodically as well. However, weight may decrease over both time and number of hops. The influence of a clusterhead node may decrease as weight is re-broadcast by non-clusterhead nodes. Thus, nodes farther away from a current clusterhead node may become clusterhead nodes themselves and form their own cluster. This may create a ripple effect through a network, eventually leading to autonomic network clustering.

A hello message may be a message that is periodically broadcast by every node. The hello message may contain an address of the node, an identity of its clusterhead, and a weight of clusterhead as observed by that node. A link state message may also be sent periodically. The link state message may contain a list of immediately adjacent neighbor nodes as seen by the broadcasting node.

A differential weight may be the difference between a weight of a clusterhead recorded at a node and a highest value of weights of known clusterheads, other than the clusterhead currently associated with that node. This value may indicate affinity of a current node with its clusterhead. The higher a difference weight, the lower the affinity. A maximum tolerable value of affinity may be given by an affinity threshold. When a differential weight falls below the affinity threshold, the node either selects another clusterhead that has the highest weight from its list of known clusterheads, or attempts to become a clusterhead itself, provided its own weight is larger than the affinity threshold.

The system may utilize elements from chaos theory to create a network for observing and composing local variables into an “order parameter”. Each node may make a decision based on the value of the order parameter, which may rapidly lead to a globally optimal solution for the network.

If a configuration of the network changes significantly, the value of the order parameter at many nodes may change causing the system to reconfigure. In the clustering algorithm, the order parameters may be a table of nodes that each node acknowledges and a route broadcast interval. When the size of the table reaches a critical threshold, a node may choose to act as a gateway and advertise such to the other nodes. Nodes in the vicinity may then use the gateway node as the cluster gateway and thus form a cluster. Randomness may be introduced into the system in the form of a random route table resetting for other solutions.

Ad hoc formation of groups, or clusters, of nodes is necessary in many areas, such as network management, sensor management, and fleet management for a military battlefield. These clusters should be formed rapidly, scale in size, and minimize network diameter so that information may be passed between nodes most efficiently, while minimizing non-mission-critical message overhead. These clusters may have an associated clusterhead or gateway.

A clusterhead is a node that is the primary point of communication for nodes of a cluster with other clusters. Clusterheads have the responsibility of routing messages from the cluster to other clusters. A gateway node may be located at edges of clusters and associated with multiple clusters.

A given network configuration may have only clusterheads or only gateways or both. The configuration should be stable under small or transient changes in topology, yet be able to rapidly reconfigure when the topology changes significantly (i.e., when groups of nodes join and/or leave, when the network is partitioned, etc.).

Conventional clustering has grouped systems that are connected statically to each other. These have been termed “multi-facility location problems”. Essentially, the problem is to identify a minimal set of m facilities to serve n clients such that the cost of serving all the clients is minimal. Conventionally heuristic solutions have been employed.

Typically, these solutions generate clusters from a connected graph, identify clusterheads for each cluster, and assign facilities to the clusterheads. The cost associated with this generated configuration may then be calculated. This procedure may be performed iteratively to identify lower cost solutions until the difference in costs between successively generated configurations falls below a certain threshold.

Clustering may be much more difficult for dynamic topologies. A cost of discovering the topology and disseminating that information globally to generate optimal configurations is may be high and become prohibitive as the size of a dynamic graph increases. This may be exacerbated by changes to the topology during a computation step. These changes may cause incorrect information to be used for calculating the configuration costs. Thus, a generated configuration may no longer be optimal.

A clustering algorithm should be able to achieve a stable configuration. A stable configuration is achieved when every network node is either a gateway node or a member of a cluster associated with a gateway node and the configuration does not change when the network undergoes a homomorphic change in its connectivity.

Key features of a clustering algorithm for dynamic topologies are scope of control, convergence interval, messaging overhead, efficiency, adaptivity, sensitivity to mobility, and stability. Scope of control is defined by whether the algorithm is distributed or centralized. A distributed algorithm is generally more scalable and has lower overhead than a centralized algorithm. Convergence Interval is defined by the time for the algorithm to converge to a stable configuration (e.g., the shorter, the better). Messaging Overhead is defined by the number of messages required to be sent/received by a node to achieve a stable configuration (e.g., the smaller, the better). For high efficiency, selected gateways should service a large number of nodes. If there are many clusters, routing overhead will be high. For high adaptivity, the network should not get stuck in a local maxima or minima and should not have the ability to look for other solutions. For low sensitivity to mobility, the network should scale with respect to the overall mobility of the nodes in the network. For high stability, the network should demonstrate the ability to remain in a configuration during insignificant changes in topology.

One conventional class of clustering algorithm is a Graph-Theoretic approach, such as a minimum dominating set algorithm or a set partitioning algorithm. This class may require global information and is mainly applicable to static topologies (e.g., high overhead for dynamic topologies). Another conventional class is an Election approach utilizing extra messaging for forming clusters and electing clusterheads, thus increasing overhead. A cluster size in an Election algorithm may not necessarily be optimal to reduce network diameter. Also, additional steps and/or messages may be required to identify gateways between clusters. Still another conventional class is an Evolutionary Search approach attempting to find a most optimal solution from a set of all possible solutions. Yet another conventional class is a Fitness-Based approach such as a simulated annealing algorithm or a genetic algorithm. This class may identify optimal solutions by defining a fitness function and grouping and regrouping a node population in successive iterations to find a “optimal fit”. A Fitness-Based approach may be slow converging and have high overhead to calculate a fitness at every iteration.

There are two primary classes of Graph-Theoretic algorithms: Minimum Dominating Set-based and Set Partitioning. A Minimum Dominating Set-based algorithm may find a subset of nodes called a dominating set and assign every node a property that is either in the dominating set or adjacent to a node in the dominating set. The members of the dominating set may then become clusterheads. A Set Partitioning algorithm may partition a set of all nodes such that nodes are grouped in clusters associated with a center that satisfies certain constraints. This is a classic multi-facility location problem in graph theory. Conventional approaches to solve this problem are mainly based on the property of minimum-cut or an iterative algorithm called Nearest Center Reclassification Algorithm (NCRA). Another approach used is the bounded, minimum-cut graph partitioning.

In Election algorithms, all nodes send messages to bid on becoming a clusterhead. A node that has the highest bid value is then mutually elected as the clusterhead. Bidding may take various forms, such as max-degree bidding, lowest identifier bidding, or max-weight bidding. Max-degree bidding elects the node with the highest degree of connectivity, having the most adjacent neighbors in a group of connected nodes, as a clusterhead. Lowest-identifier bidding elects the node with the lowest identifier in some group of connected nodes as the clusterhead. A two round flooding strategy may identify the clusterhead. In a first round, maximum node identifiers are flooded for a limited hop distance followed by a second round to flood minimum node identifiers. The lowest identifier at the end of the two rounds is elected a clusterhead. However, lowest-identifier bidding requires global coordination to initiate an election. In max-weight bidding, bids are submitted as some combination of a node's intrinsic properties, such as resources available and extrinsic properties (i.e., node degree). A node with the highest weight is elected.

Election algorithms may create clusters such that a clusterhead is exactly one hop away from every node in a cluster. The time complexity for these algorithms may be O(n) where n is the number of nodes in the network. One conventional algorithm may allow a clusterhead to be no more than d-hops away. The time complexity of this algorithm may be O(d).

Fitness-Based algorithms may develop an efficient distributed search algorithm. This distributed search algorithm may define fitness functions to evaluate criteria defined by an Election algorithm. A distributed search algorithm may further be subdivided into simulated annealing algorithms or genetic algorithms.

Simulated annealing is a probabilistic stochastic search method using a global fitness function to optimize creation of clusters and clusterheads. One conventional method uses a max-weight algorithm to elect a clusterhead for each cluster in every iteration and also uses a simulated annealing search to optimize a network such that a number of clusterheads is minimized for optimum operation.

A genetic algorithm may search by encoding a weighting criteria inside of “chromosomes” and evaluating fitness of chromosomes over each iteration. A conventional method operates in conjunction with a max-weight algorithm to minimize a number of clusterheads for optimum operation.

TABLE 1
COMPARISON OF CLUSTERING ALGORITHMS

| Features | NCRA | WCA | MaxMin | WCA-SA | WCA-Gen |
|---|---|---|---|---|---|
| Scope | Centralized | Distributed | Distributed | Distributed | Distributed |
| Convergence | Slow | Fast | Fast | Slow | Slow |
| Messaging | Highest | High | Low | High | High |
| Locality | Global | l-hop | d-hop | l-hop | l-hop |
| Efficiency | Lowest | Low | Low | High | High |
| Adaptivity | | | | | |
| Mobility | Bad | | Good | | |
| Stability | High | High | High | | |

A table comparing key features of the above algorithms is shown in Table 1 above. The features are compared based on an iteration of the algorithms between two stable configurations.

As stated above, heuristics are typically used for optimum cluster formation in dynamic adhoc networks. Heuristics trade-off accuracy with overhead. These two properties may be related non-linearly in that increased accuracy may usually be obtained with a higher than linear overhead. The conventional approaches presented above do not quantitatively consider that trade-off in their decisioning algorithms. Therefore, the relative merits of the conventional approaches may be only qualitative and may not be generalized to all aspects of an adhoc network. For example, mobility, relative node importance, link stability, conventional methods make an attempt to associate a static value of relative importance of each node, but conventional methods do not combine this static value with other aspects.

Conventional algorithms have a predetermined criteria with respect to a global “fitness”. Changing the criterion may yield vastly different “optimum” configurations. Conventional algorithms attempt to generate solutions that are efficient at both a local and a global level, and also under different conditions. This is difficult given the unpredictable nature of the network. Thus, more overhead is incurred trying to fit a solution. Most conventional algorithms also do not consider the possibility of being trapped in a local maxima or minima and thus have no approach for getting out of that state and exploring alternate states. While conventional fitness search algorithms may be capable, they are slow converging and have the danger of “chasing their own tail” as the network topology changes faster than the decisioning interval for the algorithm.

A system in accordance with the present invention utilizes self-critical behavior to create a self-configuring system without the associated costs of global messaging. Criticality may be defined as an instant at which properties or a state of a system changes suddenly. This is typically regarded as a phase change.

Thus, in a typical critically interacting system, step changes in properties occur. Self-organized criticality may be defined as an ability of a system to evolve in such a way as to approach a critical point and, then, maintain itself at that point. Since a system may mutate, a mutation may take the system either towards a more static configuration or towards a more changeable one (i.e., a smaller or larger volume of state space, a new attractor, etc.).

If a particular dynamic structure is optimum for a system, and a current configuration is too static, then the more changeable configuration may likely be more successful. If a system is currently too changeable, then a more static mutation may be selected. A system in accordance with the present invention may thereby adapt in both directions to converge on an optimum dynamic characteristic.

The adaptive system may observe and compose local variables into an “order parameter”. Each node may make a decision based on the value of the order parameter, which may rapidly lead to a globally optimal solution. If a configuration changes significantly, a value of the order parameter at many nodes may change, causing the system to reconfigure.

To avoid local maxima or minima, other possible dominating states may be identified. To achieve that objective, some randomness may be introduced into the system in the form of random route table resets to look for other solutions.

A self-critical system in accordance with the present invention may be influenced by multiple factors that enable the system to continually respond to external pressures by self-organizing itself. These factors may be positive feedback, negative feedback, interconnectivity, stigmergy, and randomness.

Positive Feedback may be defined as external inputs and neighbor interactions that may be fed back into each individual node's decisioning process and amplified. Positive feedback may allow the system to remain on the “edge of chaos”, thus enabling the system to explore a solution space when a current configuration becomes unstable or inefficient. Thus, the system may be “energized”.

Negative feedback may be defined as factors that influence and contribute to stabilization of the system. The combination of positive and negative feedback may result in non-linearities, constraints on system behavior, and unpredictability.

Interconnectivity may be defined as the interaction between a node and a number of other agents. This number should not be too large or too small. If the interconnections are too small, agents may be too independent and globally emergent system behavior may not arise. If the interconnections are too large, then the system may have very few stable states and very unpredictable behavior. Conventional Boolean Networks typically optimally have about two connections for each unit leading to optimum organizational and adaptive properties.

Stigmergy may be defined as the use of the environment to enable the individual nodes to communicate and interact. This interaction may either be deliberate or accidental. The nodes themselves may have no intelligence nor explicit purpose.

Randomness may allow the system remove itself from inefficient states and explore a solution space for better configurations. Randomness enables the system to avoid local minima or maxima.

A self-critical clustering algorithm may be a distributed algorithm in which every node observes certain critical local parameters and makes local decisions regarding its role in a cluster formation (i.e., whether to become a gateway node, whether to select another node as its gateway, etc.). Each node may make a strictly local decision, but the emergence of self-criticality may cause the system to converge with a few nodes becoming gateways and rest of the nodes forming clusters around the gateways. The system has no centralized control and no explicit election. Nodes do not send special messages to each other to elect a cluster head or a gateway.

Advantages provided by the system include fast initial clustering time, minimization of routing hops across the network, fast gateway identification, minimal messaging overhead for configuration, stable configuration under minor variations in topology (i.e., single node join/leave, etc.), and rapid re-configuration under multiple nodes join/leave. The system may define an order parameter which is composed of two factors: the size of a table of currently discovered nodes and a route broadcast interval. When the size of the table reaches a critical threshold, the node may choose to act as a gateway and advertise as such. Nodes in the vicinity may then use that node as a cluster gateway and thus form a cluster. This is an example of the “network effect” of the system wherein a dominating configuration of cluster nodes gets generated and the system gravitates towards a state effectively making it stable.

Each node may additionally maintain a countdown timer to broadcast its host table, its current gateway, and an affinity weight associated with that gateway; and a list of other known gateways and their weights. A node itself may be a gateway in which case the node may maintain a pointer to itself. The countdown timer may be incremented by the number of new hosts identified by the routing algorithm. A gateway node should be located where the clustering is maximum. When the countdown timer reaches a maximum value, the node may be allowed to broadcast its host table to neighboring nodes. The timer may then be resent and the host table cleared for a next iteration. A local decisioning algorithm may encourage the node to become a gateway if the following conditions exist: 1) the size of a node's known hosts table exceeds a certain threshold; 2) the node has reached or exceeded its broadcast interval; 3) the node is not currently associated with a gateway; and/or 4) if the node is associated with a gateway, its affinity to its current gateway is less than a maximum possible gateway weight by a fixed amount called an “affinity threshold”.

Elements of self-criticality employed by clustering algorithms may be: 1) Positive Feedback: increasing size of a known hosts table and cumulative gateway references; 2) Negative Feedback: affinity threshold and decrementing gateway weight; 3) interconnectivity: each node accepts input regarding gateway nodes from only a few neighboring nodes (typically 3); 4) stigmergy: exchange of known hosts and known gateways; and 5) randomness: route table resets and dynamic nature of the topology itself.

Self-critical systems theory has been conventionally applied to highly dynamic systems, which cannot be understood and controlled. Mobile adhoc networks present a highly dynamic system because the topology changes rapidly and sometimes erratically. A system in accordance with the present invention may apply a theory of self-criticality for optimized cluster formation in mobile adhoc networks. The system may locally control a few critical parameters to impact global behavior of a network. The SCC algorithm may adapt to network conditions better than conventional distributed algorithms for cluster formation (i.e., leader election using criteria such as node degree and node identifiers, etc.).

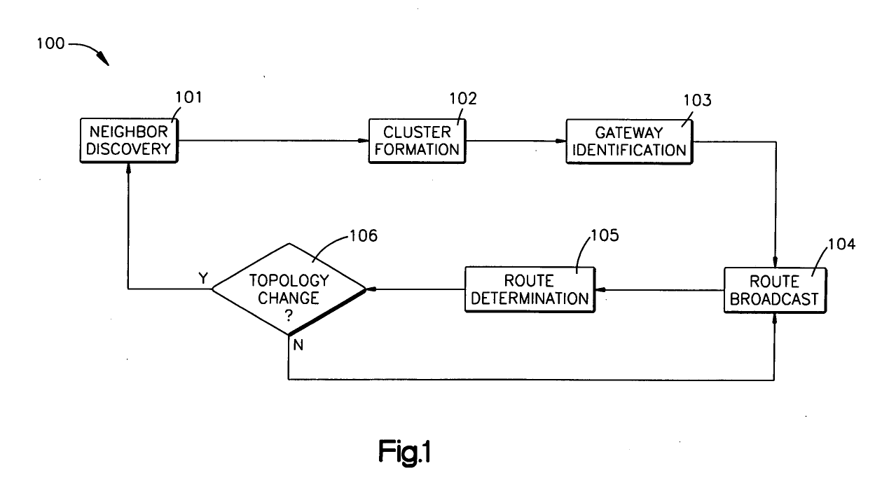

FIG. 1 shows a conventional system 100 of self-organization in ad-hoc networks that may include a topology discovery module 101, a clustering module 102, and a routing module 103. The nodes in the network may discover who their neighbors are by broadcasting “hello” messages by a route broadcast module 104. The system 100 may be organized into (non-overlapping) clusters of nodes. The nodes within each cluster may only have knowledge of each other and not of nodes outside their cluster. In each cluster, one of the nodes may become a clusterhead, or gateway, that is responsible for communication between clusters. The clusterheads may discover and communicate with each other. The entire network topology may be learned by all the clusterheads. Each clusterhead may then identify and record best routes to all the other nodes in the network in a route determination module 105.

If the system 100 determines, in a topology change module 106, that a topology change has occurred after the system 100 has stabilized, the system may start all over again. If not, a route-broadcast may repeat the broadcast to keep the information current.

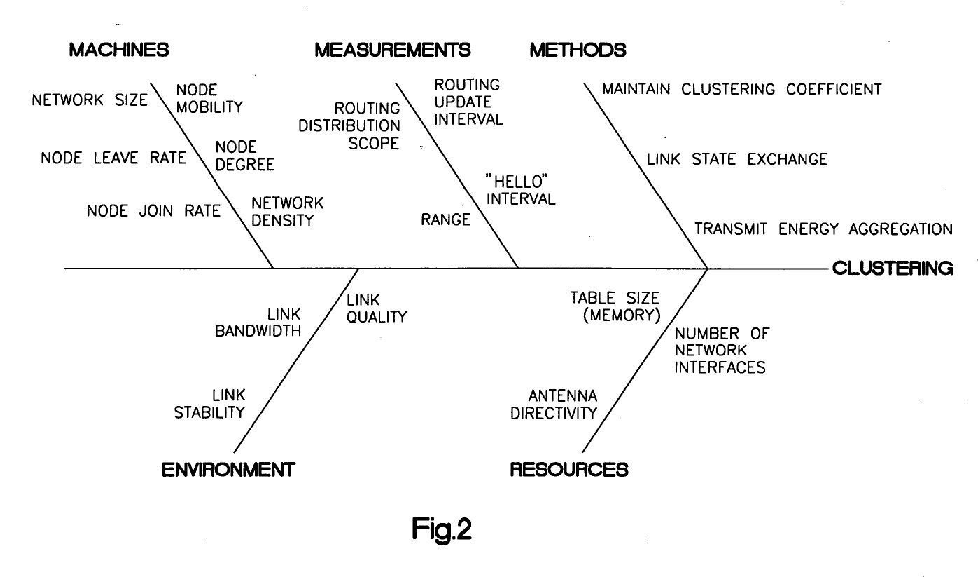

FIG. 2 shows possible factors affecting cluster formation in a systematic and categorized manner.

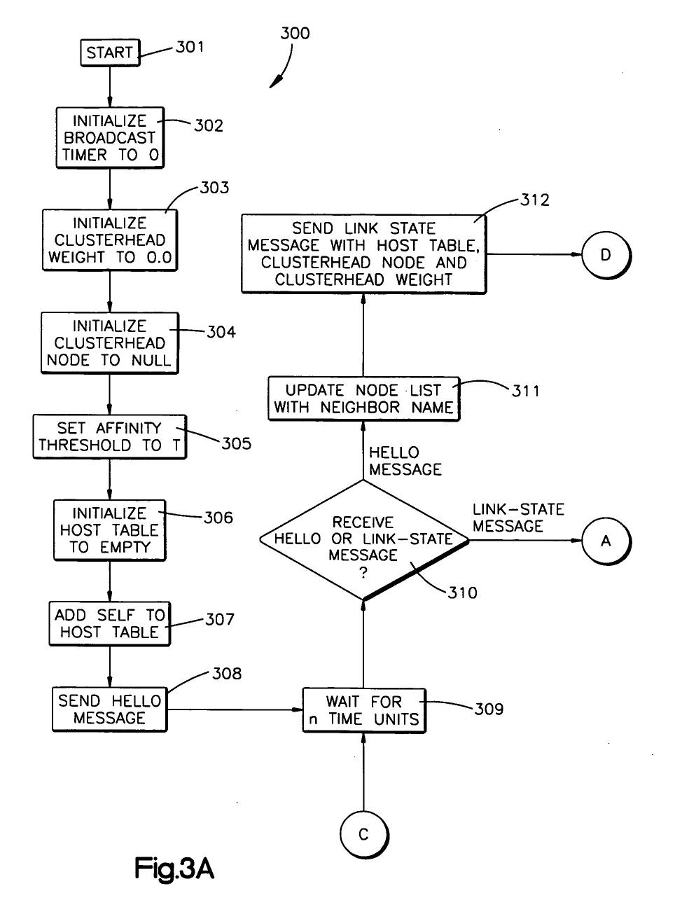

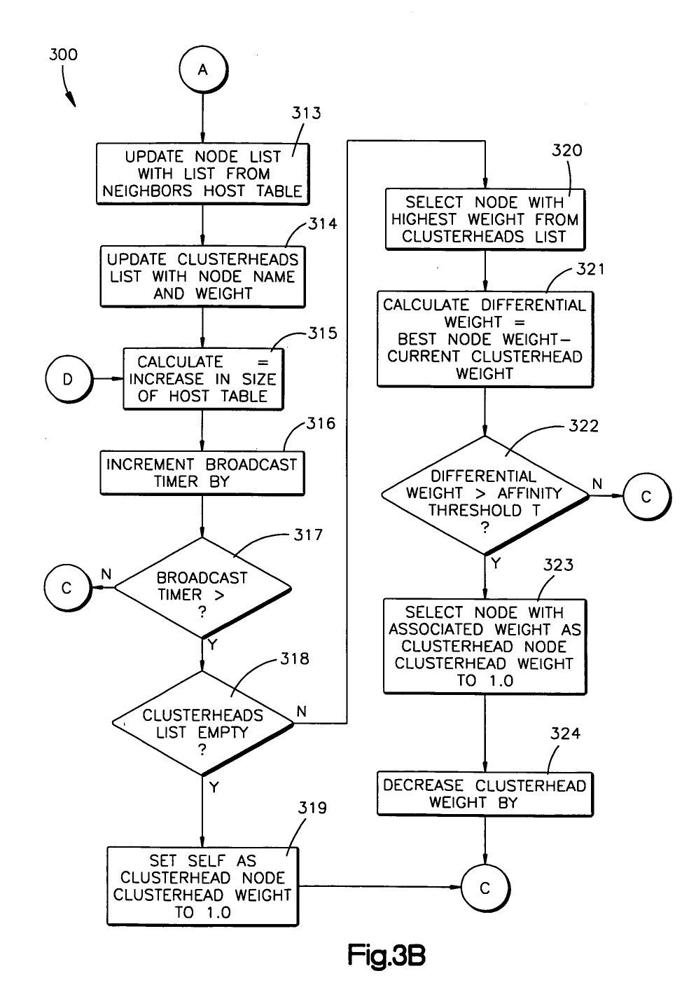

FIGS. 3A and 3B show an example system 300 in accordance with the present invention for clustering nodes of a mobile wireless network. The system 300 starts at step 301. Following step 301, the system 300 proceeds to step 302. In step 302, the system 300 initializes a broadcast timer to 0. Following step 302, the system 300 proceeds to step 303. In step 303, the system 300 initializes a clusterhead weight to 0. The system 300 initializes each node's variables with no node being a clusterhead. Following step 303, the system 300 proceeds to step 304. In step 304, the system 300 initializes a clusterhead node to NULL. Following step 304, the system 300 proceeds to step 305. In step 305, the system 300 sets an affinity threshold to T. Following step 305, the system 300 proceeds to step 306.

In step 306, the system 300 initializes a Host Table to empty. Following step 306, the system 300 proceeds to step 307. In step 307, the system 300 adds itself to the Host Table. Following step 307, the system 300 proceeds to step 308. In step 308, the system 300 broadcasts a hello message to neighboring nodes within transmission range. The hello message may contain a node name, a designated clusterhead, and a clusterhead weight. Following step 308, the system 300 proceeds to step 309. In step 309, the system 300 pauses for n time units. Following step 309, the system 300 proceeds to step 310.

In step 310, the system 300 determines whether a hello message or a link-state message has been received from a neighboring node. If a hello message has been received, the system 300 proceeds to step 311. In step 311, the system 300 updates a node list with the name of the neighboring node. Following step 311, the system 300 proceeds to step 312. In step 312, the system 300 sends link-state message containing a host table, a designated clusterhead node, and a clusterhead weight. Following step 312, the system 300 proceeds to step 313. In step 313, the system 300 updates a node list with a list from the neighboring node's host table. Following step 313, the system 300 proceeds to step 314. In step 314, the system 300 updates a clusterhead list with node name and weight. Following step 314, the system 300 proceeds to step 315.

If a link-state message has been received in step 310, the system 300 proceeds to step 313. The link-state message may contain information about a neighboring node's name and a list of neighboring clusterheads and weights. The link-state message may be broadcast to neighboring nodes within transmission range.

In step 315, the system 300 calculates α=an increase in size of the Host Table. Each iteration may calculate whether more nodes have been revealed and use this as positive feedback. Following step 315, the system 300 proceeds to step 316. In step 316, the system 300 increments a broadcast timer by α. Following step 316, the system 300 proceeds to step 317. In step 317, the system 300 determines whether the broadcast timer is greater than Γ. If the broadcast timer is not greater than Γ, the system proceeds back to step 309. If the broadcast timer is greater than Γ, the system 300 proceeds to step 318.

In step 318, the system 300 determines whether the clusterheads list is empty. If the clusterheads list is empty, the system 300 proceeds to step 319. If the clusterheads list is not empty, the system 300 proceeds to step 320.

In step 319, the system 300 sets its own node as a clusterhead node with a clusterhead weight of 1.0. Following step 319, the system 300 proceeds back to step 309.

In step 320, the system 300 selects a node with the highest weight from the clusterheads list. Following step 320, the system 300 proceeds to step 321. In step 321, the system 300 calculates a differential weight as a best node weight minus a current clusterhead weight. Following step 321, the system 300 proceeds to step 322. In step 322, the system 300 determines whether the differential weight is greater than the threshold T. If the differential weight is not greater than the threshold T, the system 300 proceeds back to step 309.

If the differential weight is greater than the threshold T, the system 300 proceeds to step 323. In step 323, the system 300 selects a node with an associated weight as a clusterhead node with a clusterhead weight of 1.0. Following step 323, the system 300 proceeds to step 324. In step 324, the system 300 decreases clusterhead weight by Δ. Following step 324, the system 300 proceeds back to step 309.

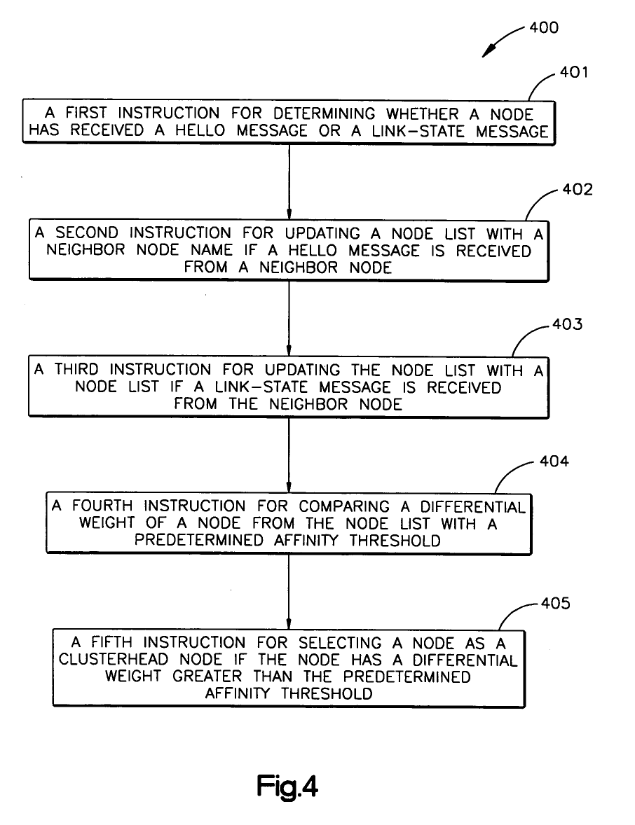

As shown in FIG. 4, an example computer program product 400 clusters nodes of a network of a plurality of nodes. The example computer program product 400 may include: a first instruction 401 for determining whether a node has received a hello message or a link-state message; a second instruction 402 for updating a node list with a neighbor node name if a hello message is received from the neighbor node; a third instruction 403 for updating the node list with a node list if a link-state message is received from the neighbor node; a fourth instruction 404 for comparing a differential weight of a node from the node list with a predetermined affinity threshold; and a fifth instruction 405 for selecting a node as a clusterhead node if the node has a differential weight greater than the predetermined affinity threshold.

In order to provide a context for the various aspects of the present invention, the following discussion is intended to provide a brief, general description of a suitable computing environment in which the various aspects of the present invention may be implemented. While the invention has been described above in the general context of computer-executable instructions of a computer program that runs on a computer, those skilled in the art will recognize that the invention also may be implemented in combination with other program modules.

Generally, program modules include routines, programs, components, data structures, etc. that perform particular tasks or implement particular abstract data types. Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like. The illustrated aspects of the invention may also be practiced in distributed computing environments where tasks are performed by remote processing devices that are linked through a communications argument model. However, some, if not all aspects of the invention can be practiced on stand-alone computers. In a distributed computing environment, program modules may be located in both local and remote memory storage devices.

An exemplary system for implementing the various aspects of the invention includes a conventional server computer, including a processing unit, a system memory, and a system bus that couples various system components including the system memory to the processing unit. The processing unit may be any of various commercially available processors. Dual microprocessors and other multi-processor architectures also can be used as the processing unit. The system bus may be any of several types of bus structure including a memory bus or memory controller, a peripheral bus, and a local bus using any of a variety of conventional bus architectures. The system memory includes read only memory (ROM) and random access memory (RAM). A basic input/output system (BIOS), containing the basic routines that help to transfer information between elements within the server computer, such as during start-up, is stored in ROM.

The server computer further includes a hard disk drive, a magnetic disk drive, e.g., to read from or write to a removable disk, and an optical disk drive, e.g., for reading a CD-ROM disk or to read from or write to other optical media. The hard disk drive, magnetic disk drive, and optical disk drive are connected to the system bus by a hard disk drive interface, a magnetic disk drive interface, and an optical drive interface, respectively. The drives and their associated computer-readable media provide nonvolatile storage of data, data structures, computer-executable instructions, etc., for the server computer. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, may also be used in the exemplary operating environment, and further that any such media may contain computer-executable instructions for performing the methods of the present invention.

A number of program modules may be stored in the drives and RAM, including an operating system, one or more application programs, other program modules, and program data. A user may enter commands and information into the server computer through a keyboard and a pointing device, such as a mouse. Other input devices (not shown) may include a microphone, a joystick, a game pad, a satellite dish, a scanner, or the like. These and other input devices are often connected to the processing unit through a serial port interface that is coupled to the system bus, but may be connected by other interfaces, such as a parallel port, a game port or a universal serial bus (USB). A monitor or other type of display device is also connected to the system bus via an interface, such as a video adapter. In addition to the monitor, computers typically include other peripheral output devices (not shown), such as speaker and printers.

The server computer may operate in a networked environment using logical connections to one or more remote computers, such as a remote client computer. The remote computer may be a workstation, a server computer, a router, a peer device or other common network node, and typically includes many or all of the elements described relative to the server computer. The logical connections include a local area network (LAN) and a wide area network (WAN). Such networking environments are commonplace in offices, enterprise-wide computer networks, intranets and the internet.

When used in a LAN networking environment, the server computer is connected to the local network through a network interface or adapter. When used in a WAN networking environment, the server computer typically includes a modem, or is connected to a communications server on the LAN, or has other means for establishing communications over the wide area network, such as the internet. The modem, which may be internal or external, is connected to the system bus via the serial port interface. In a networked environment, program modules depicted relative to the server computer, or portions thereof, may be stored in the remote memory storage device. It will be appreciated that the network connections shown are exemplary and other means of establishing a communications link between the computers may be used.

In accordance with the practices of persons skilled in the art of computer programming, the present invention has been described with reference to acts and symbolic representations of operations that are performed by a computer, such as the server computer, unless otherwise indicated. Such acts and operations are sometimes referred to as being computer-executed. It will be appreciated that the acts and symbolically represented operations include the manipulation by the processing unit of electrical signals representing data bits which causes a resulting transformation or reduction of the electrical signal representation, and the maintenance of data bits at memory locations in the memory system (including the system memory, hard drive, floppy disks, and CD-ROM) to thereby reconfigure or otherwise alter the computer system's operation, as well as other processing of signals. The memory locations where such data bits are maintained are physical locations that have particular electrical, magnetic, or optical properties corresponding to the data bits.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim:

1. A system for clustering nodes of a network of a plurality of nodes, said system comprising:
a receiver for obtaining information about a local neighborhood around a first node of the plurality of nodes, the first node having a first clusterhead node;
a compiler for generating a list of clusterhead nodes;
a recorder for recording weights of the clusterhead nodes of the list;
a processor for computing a differential weight for the clusterhead nodes of the list;
a comparator for comparing each of the differential weights with a predetermined affinity threshold; and
a determinator for determining whether the first node replaces the first clusterhead node with a new clusterhead node or the first node becomes a clusterhead node.

2. The system as set forth in claim 1 further including a clusterhead list containing potential clusterhead nodes.

3. The system as set forth in claim 2 wherein the selected clusterhead node has a clusterhead weight that is decreased by a predetermined amount.

4. The system as set forth in claim 1 wherein said determinator is located on a node with a clusterhead weight equal to one.

5. The system as set forth in claim 1 further including a differencer for calculating the differential weight as a best node weight minus a current clusterhead weight.

6. The system as set forth in claim 1 further including a calculator for calculating an increase in size of the node list.

7. The system as set forth in claim 6 wherein a broadcast timer is incremented by an increase in size of the node list.

8. The system as set forth in claim 1 further including a timer for allowing pausing of the determinator a predetermined time interval.

9. The system as set forth in claim 1 wherein the node list is set initially at empty.

10. The system as set forth in claim 1 wherein the clusterhead node has a clusterhead weight set initially at zero.

11. A computer program product for clustering nodes of a network of a plurality of nodes, said computer program product comprising:
a first instruction for obtaining information about a local neighborhood around a first node of the plurality of nodes, the first node having a first clusterhead node;
a second instruction for generating a list of clusterhead nodes;
a third instruction for recording weights of the clusterhead nodes of the list;
a fourth instruction for computing a differential weight for the clusterhead nodes of the list;
a fifth instruction for comparing each of the differential weights with a predetermined affinity threshold; and
a sixth instruction for determining whether the first node replaces the first clusterhead node with a new clusterhead node or the first node becomes a clusterhead node.

12. The computer program product as set forth in claim 11 further including a seventh instruction for providing a clusterhead list containing potential clusterhead nodes.

13. The computer program product as set forth in claim 12 wherein the selected clusterhead node has a clusterhead weight that is decreased by a predetermined amount.

14. The computer program product as set forth in claim 11 wherein the selected clusterhead node has a clusterhead weight equal to one.

15. The system as set forth in claim 1 further including a seventh instruction for calculating the differential weight as a best node weight minus a current clusterhead weight.

16. A system for clustering nodes of a network of a plurality of nodes, said system comprising:
a determinator for determining whether a node has received a hello message or a link-state message;
a node list updated with a neighbor node name if a hello message from the neighbor node was determined by the determinator, the node list being updated with a node list from a neighbor node if a link-state message was determined by said determinator;
a comparator for comparing a differential weight of a node from the node list with a predetermined affinity threshold;
a selector for selecting a node as a clusterhead node if the node has a differential weight greater than the predetermined affinity threshold; and
a calculator for calculating an increase in size of the node list.

17. The system as set forth in claim 16 wherein a broadcast timer is incremented by an increase in size of the node list.

18. The system as set forth in claim 16 further including a timer for allowing pausing of the determinator a predetermined time interval.

19. The system as set forth in claim 16 wherein the node list is set initially at empty.

20. The system as set forth in claim 16 wherein the clusterhead node has a clusterhead weight set initially at zero.
